(19) United States
(12) Patent Application Publication
(10) Pub. No.: US 2012/0327524 A1
(43) Pub. Date: Dec. 27, 2012

(54) IMAGE PICKUP LENS, LENS ARRAY, METHOD FOR PRODUCING IMAGE PICKUP LENS, AND IMAGE PICKUP MODULE

(76) Inventors: Norimichi SHIGEMITSU, Osaka-shi (JP); Hiroyuki HANATO, Osaka-shi (JP)

(21) Appl. No.: 13/431,161

(22) Filed: Mar. 27, 2012

(30) Foreign Application Priority Data
Jun. 27, 2011 (JP) 2011-142165

(51) Int. Cl. G02B 9/04; B29D 11/00; G02B 9/00

(52) U.S. Cl. 359/793; 359/754; 264/2.7

(57) ABSTRACT

A wafer-level lens of the present invention is produced by cutting out one of a plurality of lenses from at least one lens array having a wafer on which the plurality of lenses are provided, the wafer-level lens being cut out from the at least one lens array so as to have a cross section which is perpendicular to an optical axis of the wafer-level lens and is a hexagon.

This Nonprovisional application claims priority under 35 U.S.C. §119(a) on Patent Application No. 2011-142165 filed in Japan on Jun. 27, 2011, the entire contents of which are hereby incorporated by reference.

### TECHNICAL FIELD

The present invention relates to, for example, an image pickup lens (hereinafter referred to as a “wafer-level lens”) produced by a wafer-level lens process.

### BACKGROUND ART

As sales of smartphones increase and mobile phones are widespread among developing countries, there has recently been a remarkably large demand for camera modules for portable devices (mobile devices). Meanwhile, price competition among the camera modules has become more and more intense.

In view of the circumstances, a production process called a wafer-level lens process has been developed as a method for mass-producing, at low cost, image pickup lenses to be mounted in the camera modules.

The wafer-level lens process is a process for producing a wafer-level lens by the step of combining a plurality of lens arrays so as to form a lens array unit, the plurality of lens arrays each having a wafer on which a plurality of lenses are provided, and dividing the lens array unit into each combination of lenses provided in each of the plurality of lens arrays (such a step is referred to as wafer-level lens singulation). Alternatively, the wafer-level lens process is also a process for producing a wafer-level lens by the step of dividing, into each lens, a lens array which has a wafer on which a plurality of lenses are provided (such a step is referred to as wafer-level lens singulation).

Patent Literatures 1 through 3 disclose methods for producing a wafer-level lens by a wafer-level lens process.

### CITATION LIST

### Patent Literature 1

Japanese Patent Application Publication, Tokukai, No. 2011-64873 A (Publication Date: Mar. 31, 2011)

### Patent Literature 2

Japanese Patent Application Publication, Tokukai, No. 2011-62879 A (Publication Date: Mar. 31, 2011)

### Patent Literature 3

Japanese Patent Application Publication, Tokukai, No. 2011-43605 A (Publication Date: Mar. 3, 2011)

### SUMMARY OF INVENTION

### Technical Problem

In a wafer-level lens process, each lens array commonly has a plurality of lenses which are provided in an array pattern, i.e., in straight lines horizontally and vertically (see the disclosure in Examples of Patent Literature 3). Further, in a case where a plurality of lens arrays are combined to form a lens array unit and the lens array unit is divided to be singulated into each wafer-level lens, a wafer-level lens generally has a quadrilateral or circular shape.

Note here that the shape of the wafer-level lens refers to a shape of a cross section of the wafer-level lens which cross section is perpendicular to an optical axis of the wafer-level lens. Meanwhile, a shape of a lens barrel (described later) refers to a shape of a cross section of the lens barrel which cross section is parallel to the cross section of the wafer-level lens in a state in which the wafer-level lens is embedded in the lens barrel.

There is no problem with a case where a wafer-level lens having a quadrilateral shape is applied to a process for producing a sensor-integrated camera module. However, the following problem occurs in a case where the wafer-level lens obtained by singulation is embedded alone in a member such as a lens barrel.

Namely, in a case where a wafer-level lens having a quadrilateral shape is embedded in a lens barrel having a circular shape, the circular shape of the lens barrel serves as a circumcircle with respect to the quadrilateral shape of the wafer-level lens. This causes a problem of an increase in size of the lens barrel.

Further, in a case where a wafer-level lens having a quadrilateral shape is embedded in a quadrilateral lens barrel, the use itself of the quadrilateral lens barrel causes a problem of an increase in size of the lens barrel.

In contrast, there occurs a problem with a circular wafer-level lens which is difficult to singulate.

Namely, a lens array unit obtained by combining a plurality of lens arrays is cut into circular wafer-level lenses on curved cutting lines. In order to carry out the cutting on the curved cutting lines, it is necessary to cause a cutting device to curve in accordance with the cutting. This causes a problem of difficulty in singulation of a lens array into wafer-level lenses.

The present invention has been made in view of the problems, and an object of the present invention is to achieve (i) an image pickup lens that enables miniaturization of the image pickup lens and a lens barrel in which the image pickup lens is embedded and that is easily obtained by singulation, (ii) a lens array including a lens constituting the image pickup lens, (iii) a method for producing the image pickup lens, and (iv) an image pickup module including the image pickup lens.

### Solution to Problem

In order to attain the object, an image pickup lens of the present invention is produced by cutting out one of a plurality of lenses from at least one lens array having a wafer on which the plurality of lenses are provided, the image pickup lens being cut out from the at least one lens array so as to have a cross section which is perpendicular to an optical axis of the image pickup lens and is a hexagon.

A method of the present invention for producing an image pickup lens, the method includes the step of cutting out one of a plurality of lenses from at least one lens array having a wafer on which the plurality of lenses are provided, the one of the plurality of lenses being cut out so as to have a cross section which is perpendicular to an optical axis of the image pickup lens and is a hexagon.

According to the arrangement, the image pickup lens of the present invention can be used as a wafer-level lens having a hexagonal shape.

Assume that a wafer-level lens has a quadrilateral shape. The wafer-level lens can be smaller in shape merely by removing vertices and vicinities of the respective vertices from the quadrilateral shape so as to cause the wafer-level lens to have a hexagonal shape.

In addition, a circumcircle with respect to the shape of the wafer-level lens can be smaller in shape merely by removing the vertices and the vicinities of the respective vertices from the quadrilateral shape of the wafer-level lens so as to cause the wafer-level lens to have the hexagonal shape. This allows obtainment of a lens barrel which has a circular shape and in which the wafer-level lens should be embedded.

Further, in a case where a wafer-level lens is cut out from a lens array so that the wafer-level lens has a hexagonal shape, cutting lines can be formed only by straight lines. This simplifies singulation of the lens array.

A lens array of the present invention includes: on a wafer thereof, a first lens line in which a plurality of lenses are provided at a constant pitch; and a second lens line in which a plurality of lenses are provided at the constant pitch, the first lens line and the second lens line being parallel to each other, and the second lens line being constituted by the plurality of lenses each having a center which is shifted, by half the constant pitch in a direction in which the second lens line extends, from a corresponding one of centers of the respective plurality of lenses constituting the first lens line.

The arrangement allows obtainment of a lens array that makes it easy to produce a wafer-level lens having a hexagonal shape.

In other words, the lens array of the present invention is cut in three directions parallel to respective three sides of a triangle which is defined by connecting centers of respective three lenses: one lens in one of the first lens lines and two lenses which are provided in an identical one of the second lens lines and each of which is adjacent to the one lens. This makes it easy to cause the cutting lines formed only by straight lines to cut out a lens so that the lens has a hexagonal shape.

Further, in a case where adjacent lenses are provided at regular intervals, a single wafer can be provided with more lenses. This enables production of a larger number of wafer-level lenses in a short period of time.

Additionally, it can be expected that lens arrays and consequently wafer-level lenses will improve in quality, e.g., that each lens on a wafer will improve in symmetry and a distortion in the wafer will be reduced.

An image pickup module of the present invention includes: an image pickup lens of the present invention; and a lens barrel in which the image pickup lens is embedded.

The arrangement allows miniaturization of an image pickup lens and a lens barrel in which the image pickup lens should be embedded. This allows a large reduction in size of an image pickup module.

### Advantageous Effects of Invention

As described above, an image pickup lens of the present invention is produced by cutting out one of a plurality of lenses from at least one lens array having a wafer on which the plurality of lenses are provided, the image pickup lens being cut out from the at least one lens array so as to have a cross section which is perpendicular to an optical axis of the image pickup lens and is a hexagon.

A lens array of the present invention includes: on a wafer thereof, a first lens line in which a plurality of lenses are provided at a constant pitch; and a second lens line in which a plurality of lenses are provided at the constant pitch, the first lens line and the second lens line being parallel to each other, and the second lens line being constituted by the plurality of lenses each having a center which is shifted, by half the constant pitch in a direction in which the second lens line extends, from a corresponding one of centers of the respective plurality of lenses constituting the first lens line.

A method of the present invention for producing an image pickup lens, the method includes the step of cutting out one of a plurality of lenses from at least one lens array having a wafer on which the plurality of lenses are provided, the one of the plurality of lenses being cut out so as to have a cross section which is perpendicular to an optical axis of the image pickup lens and is a hexagon.

Accordingly, an effect is yielded such that (i) an image pickup lens and a lens barrel in which the image pickup lens is embedded can be smaller and (ii) a lens array can be easily singulated into an image pickup lens.

### BRIEF DESCRIPTION OF DRAWINGS

FIG. 1

(a) through (d) of FIG. 1 are perspective views showing a method of the present invention for producing an image pickup lens. In particular, (d) of FIG. 1 is the perspective view showing an arrangement of an image pickup lens of the present invention.

FIG. 2

(a) of FIG. 2 is a plan view showing how a plurality of lenses are provided in a lens array in accordance with a conventional technique. (b) of FIG. 2 is a perspective view showing an arrangement of an image pickup lens in accordance with a conventional technique.

FIG. 3

(a) of FIG. 3 is a plan view showing how a plurality of lenses are provided in a lens array in accordance with the present invention. (b) of FIG. 3 is a perspective view showing another arrangement of the image pickup lens of the present invention.

FIG. 4

FIG. 4 is a cross-sectional view showing an example of an arrangement of a camera module provided with the image pickup lens shown in (d) of FIG. 1.

FIG. 5

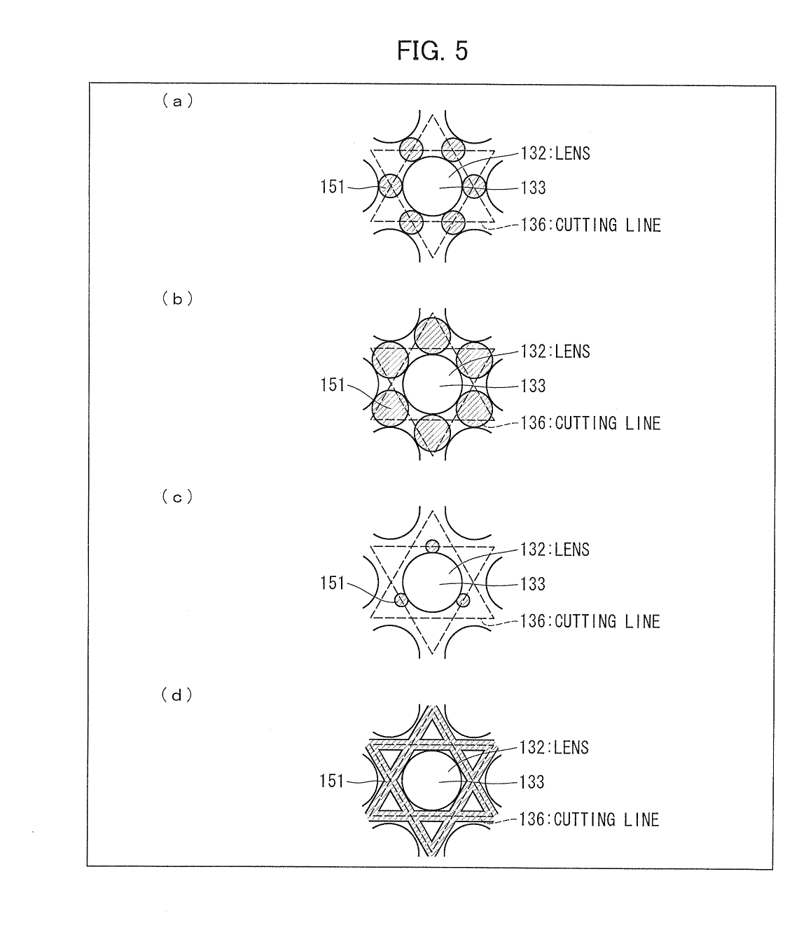

(a) through (d) of FIG. 5 are plan views schematically showing how two adjacent lens arrays are combined.

### DESCRIPTION OF EMBODIMENTS

[How Plurality of Lenses are Provided in Lens Array in Accordance with Conventional Technique]

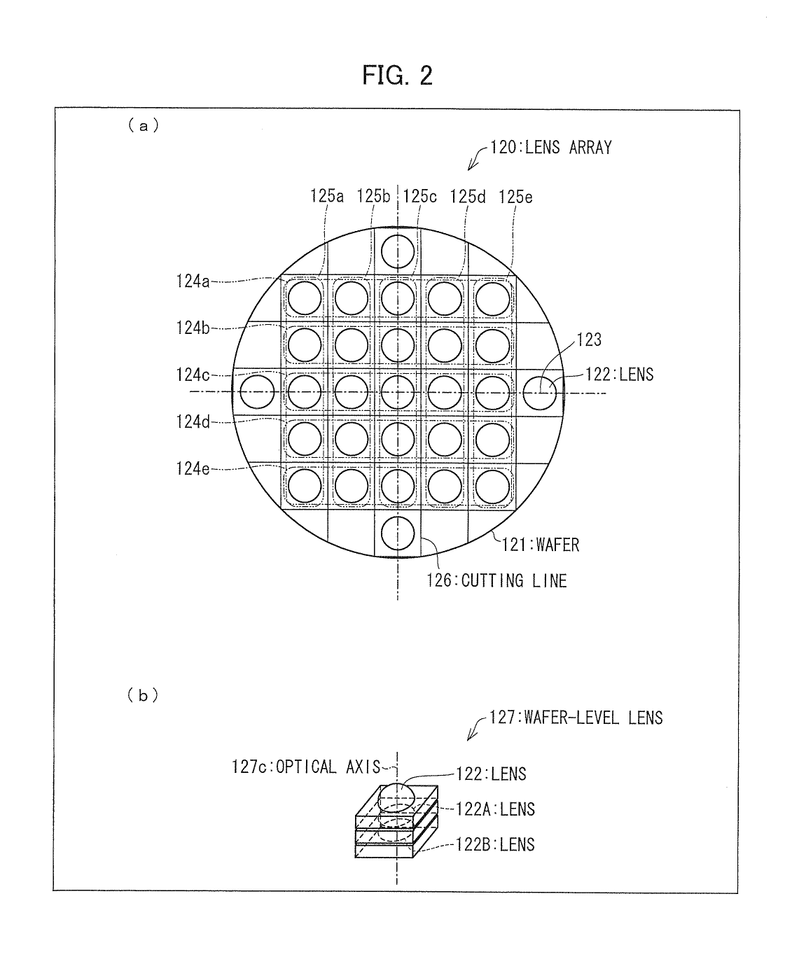

(a) of FIG. 2 is a plan view showing how a plurality of lenses are provided in a lens array in accordance with a conventional technique.

A lens array 120 shown in (a) of FIG. 2 includes a plurality of lenses 122 which are provided on a wafer 121.

The wafer 121 is made of resin, for example.

Lens surfaces are formed on both sides of the wafer 121 by subjecting, to a transfer by use of a mold, the lens surfaces (regardless of whether the lens surfaces are spherical or aspheric). A lens 122 has two lens surfaces which face each other across the wafer 121 and are formed on one and the other surfaces of the wafer 121.

The lens 122 includes an effective region 123 which is provided on its lens surfaces and functions as a lens.

Note here that in the lens array 120 shown in (a) of FIG. 2, the plurality of lenses 122 are provided, on both sides of the wafer 121, in straight lines horizontally and vertically.

Namely, the plurality of lenses 122 are provided so as to form a plurality of lens rows 124a through 124e which are parallel to each other and a plurality of lens columns 125a through 125e which are parallel to each other. It should be noted that (a) of FIG. 2 shows an arrangement in which the lens array 120 further includes a lens 122 provided on each end of the lens row 124c and a lens 122 provided on each end of the lens column 125c.

The lens array 120 is cut on cutting lines 126 shown in (a) of FIG. 2. This allows the plurality of lenses 122 provided in the lens array 120 to be cut into each lens 122.

In a case where the plurality of lenses 122 constituting the lens rows and columns are cut out from the lens array 120, especially in a case where the plurality of lenses 122 are cut out from the lens array 120 at one time, it is preferable that the cutting lines 126 be provided in a lattice pattern in plan view. Specifically, it is preferable that the cutting lines 126 be provided in a lattice pattern in which a lens 122 is provided in each region defined by the cutting lines 126.

In a case where the cutting lines 126 are provided in a lattice pattern as described above, the cutting lines 126 are straight lines extending horizontally or vertically. This makes it unnecessary to cause a cutting device (not illustrated in (a) of FIG. 2) to curve during cutout of the plurality of lenses 122. This makes it easy to cut out the plurality of lenses 122, i.e., subject the plurality of lenses 122 to singulation.

A cutting line 126 may have a circular shape so as to surround each lens 122. However, in this case, the cutting line 126 curves. This makes it difficult to subject the plurality of lenses 122 to singulation.

[Arrangement of Image Pickup Lens in Accordance with Conventional Technique]

(b) of FIG. 2 is a perspective view showing an arrangement of an image pickup lens in accordance with a conventional technique.

According to the arrangement, it is possible to produce a wafer-level lens constituted by a plurality of lenses by the step of combining a plurality of lens arrays so as to form a lens array unit, and dividing the lens array unit into each combination of lenses provided in each of the plurality of lens arrays.

Namely, a wafer-level lens 127 shown in (b) of FIG. 2 is constituted by three lens arrays: the lens array 120, a lens array 120A, and a lens array 120B. It should be noted that each of the lens array 120A and the lens array 120B is identical in arrangement to the lens array 120 except shapes of their respective lens surfaces and that the arrangement of the lens array 120A and the lens array 120B is not illustrated here for convenience.

The wafer-level lens 127 is constituted by three lenses of three different types: a lens 122 provided in the lens array 120, a lens 122A provided in the lens array 120A, and a lens 122B provided in the lens array 120B.

For example, the wafer-level lens 127 is produced by the wafer-level lens process as described below.

First, the lens array 120 and the lens array 120A are combined. In this case, the lens array 120 and the lens array 120A are combined so that the plurality of lenses 122 provided in the lens array 120 and the plurality of lenses 122A provided in the lens array 120A face each other in one-to-one correspondence.

Similarly, the lens array 120A which has been combined with the lens array 120 and the lens array 120B are combined so that the plurality of lenses 122A provided in the lens array 120A and the plurality of lenses 122B provided in the lens array 120B face each other in one-to-one correspondence.

Next, a lens array unit obtained by combining the lens array 120, the lens array 120A, and the lens array 120B is cut into each set of a lens 122, a lens 122A, and a lens 122B which face each other. Each set of the lens 122, the lens 122A, and the lens 122B which set is obtained by the cutting corresponds to each lens constituting the wafer-level lens 127.

Assume that the cutting lines 126 used for the cutting into the each set of the lens 122, the lens 122A, and the lens 122B are provided in a lattice pattern as described above. The wafer-level lens 127 has a cross-sectional shape which is perpendicular to an optical axis 127c of the wafer-level lens 127. Namely, the wafer-level lens 127 has a quadrilateral shape.

There is no problem with a case where the wafer-level lens 127 having a quadrilateral shape is applied to a process for producing a sensor-integrated camera module. However, the following problem occurs in a case where the wafer-level lens 127 obtained by singulation is embedded alone in a member such as a lens barrel.

Namely, in a case where the wafer-level lens 127 having a quadrilateral shape is embedded in a lens barrel having a circular shape, the circular shape of the lens barrel serves as a circumcircle with respect to the quadrilateral shape of the wafer-level lens 127. This causes a problem of an increase in size of the lens barrel.

Further, in a case where the wafer-level lens 127 having a quadrilateral shape is embedded in a quadrilateral lens barrel, the use itself of the quadrilateral lens barrel causes a problem of an increase in size of the lens barrel.

The problems described above similarly occur also in a case where a wafer-level lens is produced from a lens 122 by cutting a lens array 120.

[How Plurality of Lenses are Provided in Lens Array in Accordance with the Present Embodiment.]

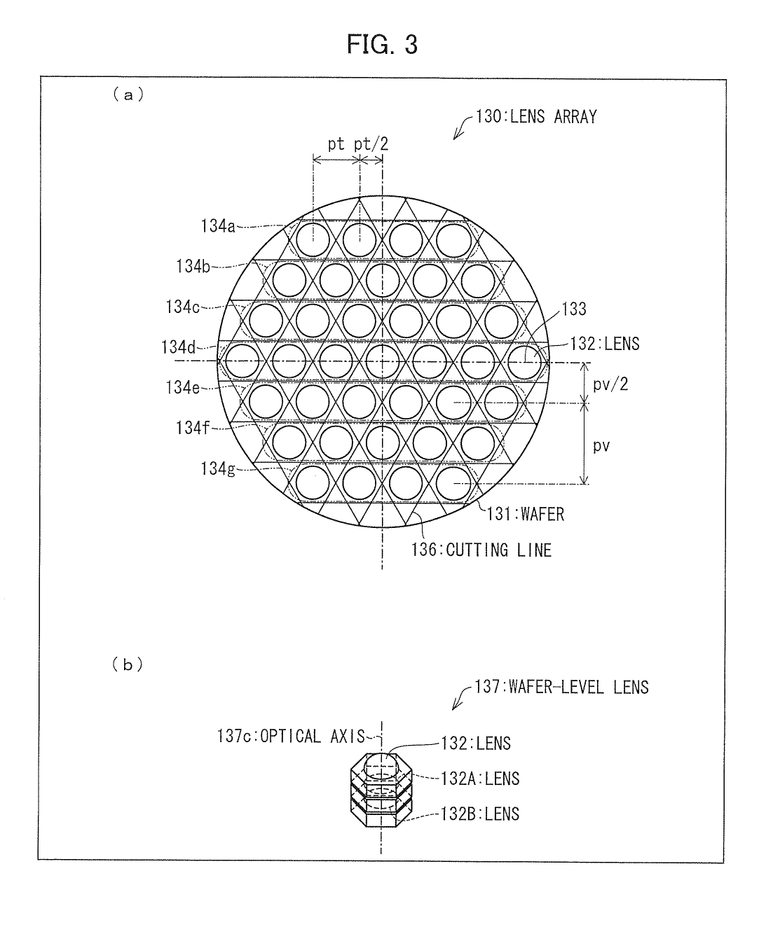

(a) of FIG. 3 is a plan view showing how a plurality of lenses are provided in a lens array in accordance with the present embodiment.

A lens array 130 shown in (a) of FIG. 3 includes a plurality of lenses 132 which are provided on a wafer 131.

The wafer 131 is made of, for example, resin, and preferably of thermosetting resin or ultraviolet curable resin.

Lens surfaces are formed on both sides of the wafer 131 by subjecting, to a transfer by use of a mold, the lens surfaces (regardless of whether the lens surfaces are spherical or aspheric). A lens 132 has two lens surfaces which face each other across the wafer 131 and are formed on one and the other surfaces of the wafer 131.

The lens 132 includes an effective region 133 which is provided on its lens surfaces and functions as a lens.

That is, the arrangement of the lens array 130 which arrangement is described above is substantially identical to that of the lens array 120.

In the lens array 130 shown in (a) of FIG. 3, the plurality of lenses 132 are provided on both sides of the wafer 131.

It should be noted here that how the plurality of lenses 132 are provided on both sides of the wafer 131 differs from how the plurality of lenses 122 are provided in the lens array 120, i.e., on both sides of the wafer 121.

The following description discusses how the plurality of lenses 132 are provided on both sides of the wafer 131.

First, the plurality of lenses 132 are provided so as to form a plurality of lens rows 134a through 134g which are parallel to each other.

The plurality of lenses 132 (here, 4 lenses) forming the lens row 134a are provided at regular intervals, i.e., provided such that two adjacent lenses 132 are provided at a constant pitch. The term “pitch” herein refers to a distance between centers of the respective two adjacent lenses 132. Same applies to the lens rows 134b through 134g.

Namely, the plurality of lenses 132 forming one of the lens rows 134a through 134g are provided such that two adjacent lenses 132 are provided at a constant pitch.

The pitch at which two adjacent lenses 132 are provided is identical in any two adjacent lenses 132 in the lens rows 134a through 134g. This pitch between two adjacent lenses 132 is hereinafter referred to as a pitch pt.

Each of the plurality of lenses 132 forming the lens row 134b is provided so as to be shifted, by half the pitch pt in a direction in which the lens rows 134a through 134g which are parallel to each other extend, from each of the plurality of lenses 132 forming the lens row 134a. Similarly, each of the plurality of lenses 132 forming the lens row 134c is provided so as to be shifted, by half the pitch pt in the direction in which the lens rows 134a through 134g extend, from each of the plurality of lenses 132 forming the lens row 134b. Same applies to each of the plurality of lenses 132 forming each of the lens rows 134c through 134g.

Namely, a center of each of the plurality of lenses 132 forming a given one of the lens rows 134a through 134g is shifted, by half the pitch pt in the direction in which the lens rows 134a through 134g extend, from a center of a corresponding one of the plurality of lenses 132 forming one or two, adjacent to the given one, of the lens rows 134a through 134g.

In (a) of FIG. 3, this distance of half the pitch pt is referred to as pt/2.

Each of the plurality of lenses 132 forming one lens row of the lens rows 134a, 134c, 134e, and 134g is shifted, by an integral number multiple of the pitch pt in the direction in which the lens rows 134a through 134g extend, from each of the plurality of lenses 132 forming another lens row of the lens rows 134a, 134c, 134e, and 134g. In other words, among the lens rows 134a, 134c, 134e, and 134g, substantially no such shift in centers of the plurality of lenses 132 as mentioned above occurs. The lens rows 134a, 134c, 134e, and 134g in such a relationship can be regarded as “first lens lines” in accordance with the present embodiment.

Each of the plurality of lenses 132 forming one lens row of the lens rows 134b, 134d, and 134f is shifted, by an integral number multiple of the pitch pt in the direction in which the lens rows 134a through 134g extend, from each of the plurality of lenses 132 forming another lens row of the lens rows 134b, 134d, and 134f. In other words, among the lens rows 134b, 134d, and 134f, substantially no such shift in centers of the plurality of lenses 132 as mentioned above occurs. The lens rows 134b, 134d, and 134f in such a relationship can be regarded as “second lens lines” in accordance with the present embodiment.

Alternatively, each of the first lens lines can be regarded as each of odd-numbered rows of the lens rows, and each of the second lens lines can be regarded as each of even-numbered rows of the lens rows.

In addition, the plurality of lenses 132 are provided on the wafer 131 so as to form a plurality of lens columns which are parallel to each other in a direction that is perpendicular to the direction in which the lens rows 134a through 134g extend. How the plurality of lens columns are provided is similar in characteristic to how the lens rows 134a through 134g are provided, and a specific description thereof is omitted here.

Instead, (a) of FIG. 3 illustrates, as a pitch pv, a pitch which corresponds to the pitch pt and at which adjacent lenses 132 in each of the plurality of the lens columns are provided. Further, (a) of FIG. 3 illustrates, as pv/2, a distance which is half the pitch pv and serves as a criterion of an amount by which lenses 132 are shifted from each other between two adjacent lens columns.

The lens array 130 is cut on cutting lines 136 shown in (a) of FIG. 3. This allows the plurality of lenses 132 provided in the lens array 130 to be cut into each lens 132.

In a case where the plurality of lenses 132 are cut from the lens array 130, especially in a case where the plurality of lenses 132 are cut out from the lens array 130 at one time, it is preferable that the cutting lines 136 be determined as described below in plan view.

Namely, the cutting lines 136 have as many regular hexagons as the number of the plurality of lenses 132 provided in the lens array 130. The regular hexagons and the lenses 132 are in one-to-one correspondence such that each of the regular hexagons surrounds a corresponding lens 132. Further, the cutting lines 136 are determined so that a region which is defined by three of the regular hexagons and surrounds no lens 132 is a regular triangle.

Note that in the lens array 130 shown in (a) of FIG. 3, the plurality of lenses 132 are provided so as to form regular hexagons on the surfaces of the wafer 131. In this case, the cutting lines 136 are determined so that regions which surround all the respective plurality of lenses 132 provided in the lens array 130 are regular hexagons.

The cutting lines 136 are constituted by only three types of straight lines which are at angles of 0°, 60°, and 120° respectively, with respect to the direction in which the lens rows 134a through 134g extend. This makes it unnecessary to cause a cutting device (not illustrated in (a) of FIG. 3) to curve during cutout of the plurality of lenses 132. This makes it easy to cut out the plurality of lenses 132, i.e., subject the plurality of lenses 132 to singulation.

The lens array 130 as arranged above makes it easy to produce wafer-level lenses having a hexagonal shape.

Namely, in a case where the lens array 130 is cut on the cutting lines 136, which are constituted only by straight lines, a lens 132 can be easily cut out from the lens array 130 so that the lens 132 has a hexagonal shape.

In other words, the lens array 130 is cut in three directions parallel to respective three sides of a triangle which is defined by connecting centers of respective three lenses 132: one lens 132 in one of the first lens lines and two lenses 132 which are provided in an identical one of the second lens lines and each of which is adjacent to the one lens 132. This makes it easy to cause the cutting lines 136 formed only by straight lines to cut out a lens 132 so that the lens 132 has a hexagonal shape.

Further, in a case where adjacent lenses are provided at regular intervals, a single wafer 131 can be provided with more lenses 132. This enables production of a larger number of wafer-level lenses in a short period of time.

Additionally, it can be expected that lens arrays and consequently wafer-level lenses will improve in symmetry, e.g., that each lens 132 on the wafer 131 will improve in quality and a distortion in the wafer 131 will be reduced.

[Method in Accordance with the Present Embodiment for Producing Image Pickup Lens and Arrangement of the Image Pickup Lens]

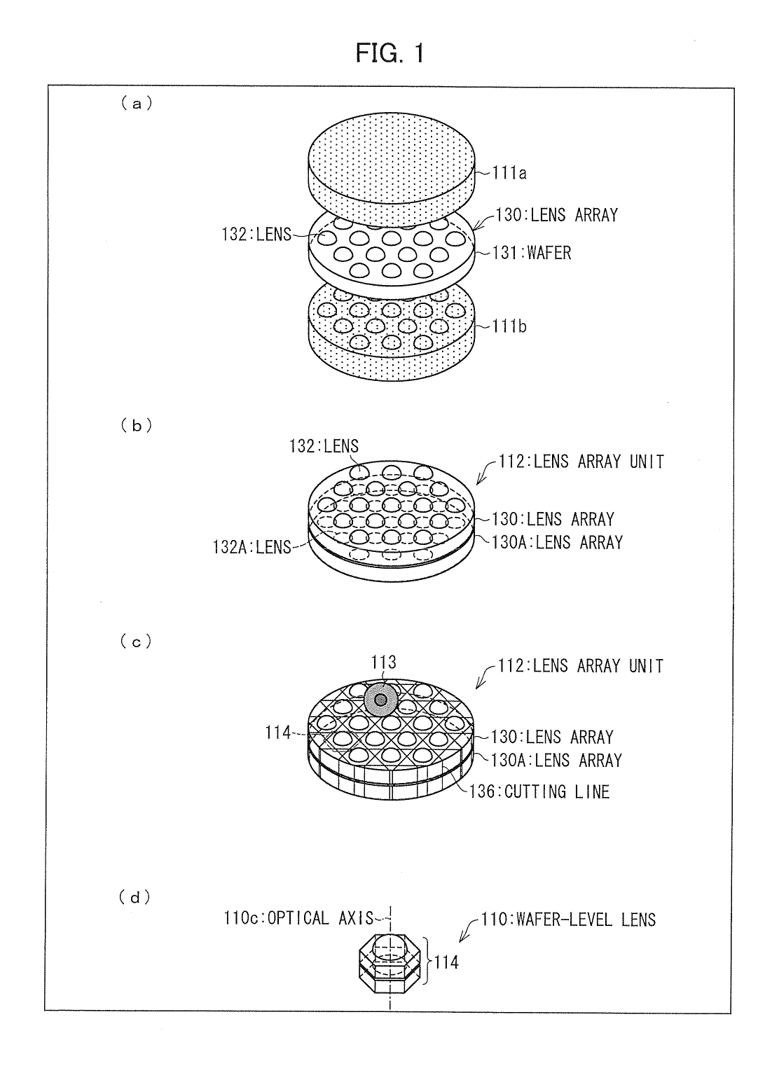

(a) through (d) of FIG. 1 are perspective views showing a method in accordance with the present embodiment for producing an image pickup lens. In particular, (d) of FIG. 1 is the perspective view showing an arrangement of the image pickup lens in accordance with the present embodiment.

A wafer-level lens (image pickup lens) 110 shown in (d) of FIG. 1 is produced by the wafer-level lens process. This makes it possible to mass-produce the wafer-level lens 110 in a short period of time, so that production costs can be reduced. The wafer-level lens 110 may be subjected to reflow soldering in a case where the wafer-level lens 110 is made of thermosetting resin or ultraviolet curable resin.

The method for producing the wafer-level lens 110 is described below with reference to (a) of FIG. 1 through (d) of FIG. 1.

The following description discusses the step shown in (a) of FIG. 1.

A wafer 131 made of resin (preferably thermosetting resin or ultraviolet curable resin) is sandwiched between an upper mold 111a and a lower mold 111b, heated so as to be cured, and formed in a lens array 130.

Note here that in order to allow a plurality of one lens surfaces of respective lenses 132 to be formed on the wafer 131, a plurality of surfaces which are opposite in shape to the respective plurality of one lens surfaces are formed on a surface (transfer surface) of the upper mold 111a which surface faces the wafer 131 that is sandwiched between the mold 111a and the mold 111b.

Similarly, in order to allow a plurality of the other lens surfaces of the respective lenses 132 to be formed on the wafer 131, a plurality of surfaces which are opposite in shape to the respective plurality of the other lens surfaces are formed on a surface of the lower mold 111b which surface faces the wafer 131 that is sandwiched between the mold 111a and the mold 111b.

Furthermore, (i) the plurality of surfaces which are formed on the upper mold 111a and are opposite in shape to the respective plurality of one lens surfaces of the respective lenses 132 and (ii) the plurality of surfaces which are formed on the lower mold 111b and are opposite in shape to the respective plurality of the other lens surfaces of the respective lenses 132 are provided in one-to-one correspondence so that corresponding surfaces face each other when the wafer 131 is sandwiched between the upper mold 111a and the lower mold 111b.

A combination of lenses which are formed in the lens array 130 and face each other serves as a lens 132.

As in the case of this example, a separate wafer than the wafer 131 is formed in a separate lens array than the lens array 130 by use of molds. The separate lens array than the lens array 130 is hereinafter referred to as a lens array 130A. It should be noted that the lens array 130 and the lens array 130A have an identical arrangement except shapes of their respective lens surfaces.

The following description discusses the step shown in (b) of FIG. 1.

The lens array 130 and the lens array 130A, each of which is produced in the step shown in (a) of FIG. 1, are combined. A unit obtained by combining the lens array 130 and the lens array 130A that are adjacent to each other in a direction in which an optical axis 110c of the wafer-level lens 110 extends is referred to as a lens array unit 112.

In this case, the lens array 130 and the lens array 130A are combined so that the lenses 132 formed in the lens array 130 and their corresponding lenses 132A formed in the lens array 130A face each other. More preferably, the lens array 130 and the lens array 130A are combined so that the lenses 132 formed in the lens array 130 and the corresponding lenses 132A formed in the lens array 130A, the lenses 132 and the corresponding lenses 132A being adjacent to each other in the direction in which the optical axis 110c of the wafer-level lens 110 extends, are provided in one-to-one correspondence so as to face each other.

More specifically, it is an ideal arrangement that, after the lens array 130 and the lens array 130A are combined, a lens 132 and a lens 132A provided to face each other have their respective optical axes which are collinear.

The following description discusses the step shown in (c) of FIG. 1.

The lens array unit 112 is cut by use of a cutting device 113.

The cutting device 113 carries out the cutting considering a lens combination 114 as a unit, the lens combination 114 being a set of a lens 132 and a lens 132A facing each other. Not to mention, the cutting is carried out on the cutting lines 136 to be determined in the lens array 130 and the lens array 130A.

(d) of FIG. 1 shows a lens combination 114 which has been subjected to the cutting by use of the cutting device 113.

The lens combination 114 shown in (d) of FIG. 1 corresponds to the wafer-level lens 110.

The wafer-level lens 110 produced by cutting the lens array unit 112 on the cutting lines 136 has a cross section, i.e., a shape that is hexagonal, the cross section being perpendicular to the optical axis 110c of the wafer-level lens 110.

The wafer-level lens 110 can be used as a wafer-level lens having a hexagonal shape.

A wafer-level lens can be smaller in shape merely by arranging the wafer-level lens 110 having a hexagonal shape by removing vertices and vicinities of the respective vertices from the quadrilateral shape of the wafer-level lens 127 (see (b) of FIG. 2).

In addition, a circumcircle with respect to the shape of the wafer-level lens can be smaller merely by arranging the wafer-level lens 110 having the hexagonal shape by removing the vertices and the vicinities of the respective vertices from the quadrilateral shape of the wafer-level lens 127. This allows obtainment of a smaller lens barrel which has a circular shape and in which the wafer-level lens should be embedded.

Further, in a case where the wafer-level lens 110 is cut out from the lens array unit 112 so that the wafer-level lens 110 has a hexagonal shape, the cutting lines 136 can be formed only by straight lines. This simplifies the singulation of the lens array unit 112.

It should be noted that it is common to arrange a wafer-level lens for real use by mounting, on the wafer-level lens 110, components such as an aperture stop and a cover glass for protecting an image plane of the wafer-level lens.

The number of lenses included in the wafer-level lens in accordance with the present invention is not limited to two, but may be one, or may be three or more.

In a case where the number of the lenses is one, no lens array unit is formed, and one lens array instead of a lens array unit is cut so as to produce the wafer-level lens.

In contrast, assume that the number of the lenses is three or more. In this case, the wafer-level lens is produced by use of three or more lens arrays as follows: A lens array unit is formed by combining adjacent lens arrays of the three or more lens arrays, and the lens array unit thus formed is cut, so that the wafer-level lens is produced.

(b) of FIG. 3 is a perspective view showing another arrangement of the image pickup lens in accordance with the present embodiment.

A wafer-level lens 137 is produced by use of three lens arrays: a lens array 130, a lens array 130A, and a lens array 130B. It should be noted that the lens array 130B is arranged as in the case of the lens array 130 except shapes of respective lens surfaces, and the arrangement is not illustrated here for convenience. Further, the lens array 130B and the lens array 130A which are adjacent to each other are combined during the wafer-level lens process mentioned above.

The wafer-level lens 137 is constituted by three lenses of three different types: a lens 132 provided in the lens array 130, a lens 132A provided in the lens array 130A, and a lens 132B provided in the lens array 130B.

Further, the wafer-level lens 137 has a cross section, i.e., a shape that is hexagonal, the cross section being perpendicular to an optical axis 137c.

[Arrangement of Camera Module Including Image Pickup Lens in Accordance with Present Embodiment]

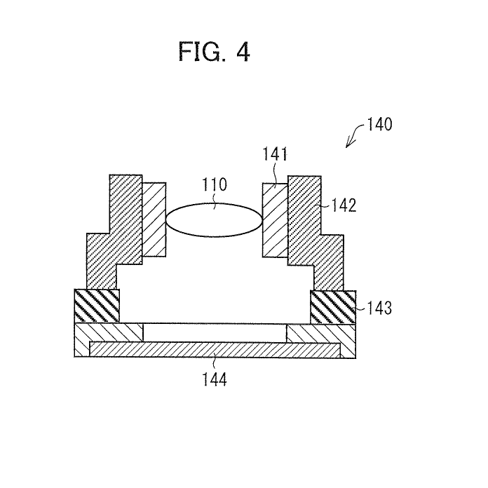

FIG. 4 is a cross-sectional view showing an example of an arrangement of a camera module including the image pickup lens shown in (d) of FIG. 1.

A camera module (an image pickup module) 140 shown in FIG. 4 is arranged by embedding, in a lens barrel 141, the wafer-level lens 110 shown in (d) of FIG. 1.

The lens barrel 141, in which the wafer-level lens 110 is embedded, is a cylindrical or hexagonal cylindrical member. Note here that the “hexagonal cylindrical” refers to a cylinder having a cross section that is hexagonal, the cross section being perpendicular to a length direction (a direction in which the wafer-level lens is embedded in the cylinder via an opening of the cylinder).

The wafer-level lens 110 is embedded in the lens barrel 141 so that all of the lens surfaces face the length direction of the lens barrel 141. Meanwhile, a side surface of the wafer-level lens 110 is fixed by a side surface of the lens barrel 141.

The wafer-level lens 110 has a hexagonal shape as mentioned above. Meanwhile, the lens barrel 141 has a circular shape in a case where the lens barrel 141 is cylindrical, and the lens barrel 141 has a hexagonal shape in a case where the lens barrel 141 is hexagonal cylindrical. Note here that the “shape of the lens barrel 141” refers to a shape of a cross section of the lens barrel 141, the cross section being parallel to a cross section defining the shape of the wafer-level lens 110 in a state in which the wafer-level lens 110 is embedded in the lens barrel 141. The shape of the lens barrel 141 is identical to the shape of the cross section of the lens barrel 141, the cross section being perpendicular to the length direction of the lens barrel 141.

In a case where the lens barrel 141 is cylindrical, the side surface of the lens barrel 141 allows the wafer-level lens 110 to be fixed in the lens barrel 141 by causing the circular shape of the lens barrel 141 to be a circumcircle with respect to the hexagonal shape of the wafer-level lens 110.

In a case where the lens barrel 141 is hexagonal, the side surface of the lens barrel 141 allows the wafer-level lens 110 to be fixed in the lens barrel 141 by causing the hexagonal shape of the lens barrel 141 and the hexagonal shape of the wafer-level lens 110 to match with each other.

The camera module 140 shown in FIG. 4 further includes a lens holder 142, an AF (autofocus) etc. mechanism system 143, and a solid-state image pickup sensor 144.

The lens holder 142 is a housing that contains the wafer-level lens 110 and the lens barrel 141.

The AF (autofocus) etc. mechanism system 143 carries out an autofocus function in the camera module 140. The AF (autofocus) etc. mechanism system 143 carries out a variety of functions in addition to the autofocus function.

The solid-state image pickup sensor 144 is configured by a CCD (Charge Coupled Device), a CMOS (Complementary Metal Oxide Semiconductor), or the like. The solid-state image pickup sensor 144 receives, as light, an image formed in the wafer-level lens 110.

It can be said that the camera module 140 allows the wafer-level lens 110 and the lens barrel 141 to be smaller.

[How to Combine Two Adjacent Lens Arrays]

(a) through (d) of FIG. 5 are plan views schematically showing how two adjacent lens arrays are combined.

The lens array unit 112 is preferably arranged such that adjacent lens arrays are combined at at least either one of vertices and sides of a hexagon defined by the cutting lines 136.

(a) through (d) of FIG. 5 show specific examples of how adhesion sections 151 for adhering the lens array 130A to the lens array 130 are provided in the lens array 130 so as to combine the lens array 130 and the lens array 130A which are adjacent to each other.

(a) of FIG. 5 shows how adhesion sections 151 are provided at six vertices of a hexagon which is defined by the cutting lines 136 and surrounds a lens 132.

(b) of FIG. 5 shows how adhesion sections 151 are provided at six sides of a hexagon which is defined by the cutting lines 136 and surrounds a lens 132. Note that the adhesion sections 151 shown in (b) of FIG. 5 are larger in size than the adhesion sections 151 shown in (a) of FIG. 5.

(c) of FIG. 5 shows how adhesion sections 151 are provided at three sides of six sides of a hexagon which is defined by the cutting lines 136 and surrounds a lens 132, the three sides being not adjacent to each other. Note that the adhesion sections 151 shown in (c) of FIG. 5 are smaller in size than the adhesion sections 151 shown in (a) of FIG. 5.

(d) of FIG. 5 shows how adhesion sections 151 are provided at (i) six vertices and six sides of a hexagon which is defined by the cutting lines 136 and surrounds a lens 132 and (ii) three vertices and three sides of each triangle which is defined by the cutting lines 136 and has one side that is one of the six sides of the hexagon.

According to the arrangement, adjacent lens arrays can be adhered to each other more freely while being combined.

For example, in a case where adhesion sections 151 are provided in symmetry with respect to a center of a lens 132, adjacent lens arrays can be combined stably. Furthermore, the wafer-level lens 110 having a hexagonal shape can be fixed by adhesion more freely as compared to a wafer-level lens having a quadrilateral shape.

For example, in a case where a wafer-level lens having a quadrilateral shape is subjected to adhesion in the adhesion sections 151 which are provided so as to be dotted, it is realistically assumed that the adhesion is carried out at four points which correspond to four corners of the quadrilateral shape. In contrast, it is possible to apply, to the wafer-level lens 110 having a hexagonal shape, a wider variety of adhesion structures such as six adhesion sections (see (a) and (b) of FIG. 5) and three adhesion sections (see (c) of FIG. 5).

For example, in a case where a heat-resistant reflowable lens is arranged to have a hexagonal shape, the following effect may be yielded by carrying out multipoint adhesion which is more symmetrical with respect to the center of the lens 132. Namely, it is possible to achieve a structure which is highly resistant to characteristic deteriorations in the lens 132 such as decentering due to a distortion in the lens 132 caused by thermal history in accordance with a difference in thermal expansion.

The image pickup lens of the present invention is preferably arranged such that: the image pickup lens is produced by cutting out, from a lens array unit which includes a plurality of the at least one lens array and is formed by combining adjacent lens arrays which are adjacent to each other in a direction of the optical axis, one of the plurality of lenses for each of the plurality of the at least one lens array; and the one of the plurality of lenses for the each of the plurality of the at least one lens array is formed by combining adjacent lenses which are adjacent to each other in the direction of the optical axis.

The method of the present invention for producing an image pickup lens is preferably arranged to further include the steps of: (a) producing a lens array unit by using a plurality of the at least one lens array and combining adjacent lens arrays which are adjacent to each other in a direction of the optical axis; (b) cutting out, from the lens array unit, one of the plurality of lenses for each of the plurality of the at least one lens array; and (c) in the step (a), combining adjacent lenses which are adjacent to each other in the direction of the optical axis, so as to form the one of the plurality of lenses for the each of the at least one lens array.

According to the arrangement, a wafer-level lens and a lens barrel in which the wafer-level lens is embedded can be smaller in shape and singulation into the wafer-level lens can be easily carried out, the wafer-level lens (i) having been cut out from a lens array unit formed by combining a plurality of lens arrays and (ii) including a plurality of lenses.

The image pickup lens of the present invention is preferably arranged such that in the lens array unit, the adjacent lens arrays are combined at at least either one of vertices and sides of the hexagon.

According to the arrangement, adjacent lens arrays can be adhered to each other more freely while being combined.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be applied to a wafer-level lens.

### REFERENCE SIGNS LIST

110 Wafer-level lens (image pickup lens)
110c Optical axis
112 Lens array unit
130, 130A, 130B Lens array
131 Wafer
132, 132A, 132B Lens
134a, 134c, 134e, 134g Lens rows (first lens lines)
134b, 134d, 134f Lens columns (second lens lines)
136 Cutting Lines
137 Wafer-level lens (image pickup lens)
137c Optical axis
140 Camera module (image pickup module)
141 Lens barrel
pt Pitch

1. An image pickup lens produced by cutting out one of a plurality of lenses from at least one lens array having a wafer on which the plurality of lenses are provided,
the image pickup lens being cut out from the at least one lens array so as to have a cross section which is perpendicular to an optical axis of the image pickup lens and is a hexagon.

2. The image pickup lens as set forth in claim 1, wherein:
the image pickup lens is produced by cutting out, from a lens array unit which includes a plurality of the at least one lens array and is formed by combining adjacent lens arrays which are adjacent to each other in a direction of the optical axis, one of the plurality of lenses for each of the plurality of the at least one lens array; and
the one of the plurality of lenses for the each of the plurality of the at least one lens array is formed by combining adjacent lenses which are adjacent to each other in the direction of the optical axis.

3. The image pickup lens as set forth in claim 2, wherein in the lens array unit, the adjacent lens arrays are combined at at least either one of vertices and sides of the hexagon.

4. A lens array comprising:
on a wafer thereof,
a first lens line in which a plurality of lenses are provided at a constant pitch; and
a second lens line in which a plurality of lenses are provided at the constant pitch,
the first lens line and the second lens line being parallel to each other, and
the second lens line being constituted by the plurality of lenses each having a center which is shifted, by half the constant pitch in a direction in which the second lens line extends, from a corresponding one of centers of the respective plurality of lenses constituting the first lens line.

5. A method for producing an image pickup lens, the method comprising the step of cutting out one of a plurality of lenses from at least one lens array having a wafer on which the plurality of lenses are provided, the one of the plurality of lenses being cut out so as to have a cross section which is perpendicular to an optical axis of the image pickup lens and is a hexagon.

6. The method as set forth in claim 5, further comprising the steps of:
(a) producing a lens array unit by using a plurality of the at least one lens array and combining adjacent lens arrays which are adjacent to each other in a direction of the optical axis;
(b) cutting out, from the lens array unit, one of the plurality of lenses for each of the plurality of the at least one lens array; and
(c) in the step (a), combining adjacent lenses which are adjacent to each other in the direction of the optical axis, so as to form the one of the plurality of lenses for the each of the at least one lens array.

7. An image pickup module comprising:
an image pickup lens produced by cutting out one of a plurality of lenses from at least one lens array having a wafer on which the plurality of lenses are provided, the image pickup lens being cut out from the at least one lens array so as to have a cross section which is perpendicular to an optical axis of the image pickup lens and is a hexagon; and
a lens barrel in which the image pickup lens is embedded.
